(19) United States
(12) Patent Application Publication
(10) Pub. No.: US 2026/0184152 A1
(43) Pub. Date: Jul. 2, 2026

(54) TRUCK BED MAT FOR GOOSENECK OR FIFTH WHEEL TRAILER HITCHES

(71) Applicant: Master Tool & Mfg., Inc., Hiawatha, IA (US)

(72) Inventors: Clint Bitterman, Cedar Rapids, IA (US); Robert Bitterman, Cedar Rapids, IA (US)

(73) Assignee: Master Tool & Mfg., Inc., Hiawatha, IA (US)

(21) Appl. No.: 19/004,976

(22) Filed: Dec. 30, 2024

(51) Int. Cl. B60J 11/06; B60R 13/01

(52) U.S. Cl. CPC B60J 11/06; B60R 13/01

(57) ABSTRACT

The invention involves the use of a replaceable truck bed mat cutout portion to access areas of a truck bed where a gooseneck or fifth wheel trailer hitch would be installed. These replaceable cutout portions can easily be removed and reinserted without tools. When the shaped cutout is either removed, or flipped open via a hinge, it provides access to towing connection points mounted in the bed of the truck, such as a gooseneck system, or a fifth wheel hitch system. These cutout portions also have a design which includes a number of interlocking tabs along the edge of the shaped cutout that interface with the surrounding area of the truck bed mat. These interlocking tabs help to hold the shaped cutout in place when access to the area of the truck bed where a gooseneck of fifth wheel hitch would be installed is not needed.

### FIELD OF THE INVENTION

The invention relates generally to truck bed mats and their use in conjunction with certain types of towing equipment. In particular, this invention discloses a truck bed mat that can be used with an in-bed towing apparatus, such as a gooseneck or fifth wheel hitch.

### BACKGROUND

Trailer hitches are commonly used with a variety of different types of powered vehicles for towing trailers. Trailers are generally unpowered vehicles which are designed to be towed or pulled by powered vehicles. Trailers can serve to transport a variety of different materials, such as tools, homes, boats, and even other vehicles. Trailer hitches are generally attached to the chassis of the powered vehicle, and in many cases will be mounted on the rear of the powered vehicle on either the frame or the bumper.

While most trailers are pulled by powered vehicles with bumper-mounted hitches, these arrangements are often inadequate to handle large loads. When transporting large loads, such as 10,000-to-30,000-pound trailers, bumper-mounted hitches are prone to sway or fishtail while driving due to the difference in centers of gravity between the two vehicles. In those circumstances, the hitch acts as a pivot point, which can cause any trailer sway or side-to-side force to turn the powered vehicle and create unsafe driving conditions. Accordingly, large load trailers will often be towed using either fifth wheel or gooseneck hitches. These hitches can be attached to a truck bed and will be mounted above the rear axle of the truck to both better support the weight, as well as to change the location of the pivot point from between the powered vehicle and the trailer to above the rear axle of the powered vehicle.

While fifth wheel and gooseneck hitches share superficial similarities, they have different methods for coupling the powered vehicle and the trailer. In the case of gooseneck mounts, the trailer will couple to a standard sized ball mounted on the bed of the tow vehicle. In the case of Fifth wheel hitches, the powered vehicle will have a large horseshoe-shaped coupling device that will connect with a vertical steel pin, also known as a kingpin, protruding from the bottom of the trailer connection point. The surface of the fifth wheel coupler will be upward-facing and the corresponding kingpin will be downward-facing, such that when the towing vehicle turns, the surface of the trailer connection point rotates against the fifth wheel.

Bed mats are commonly used in trucks to cover the bottom of the cargo bed of the truck for a variety of purposes. Bed mats can protect the surface of the bed from wear such as dents or scratches. They can also protect the cargo bed from mud, dirt, salt, or rain. However, as truck beds typically cover the entirety of the cargo bed, it is not possible to use bed mats with in-bed towing apparatuses as described above. Using a fifth wheel or gooseneck towing system would require an operator to remove the entirety of the bed mat before installing and/or operating the towing system. This is undesirable for several reasons. First, bed mats can be both heavy and cumbersome due to their size and shape. Additionally, removing the bed mat exposes the truck bed to both physical wear and tear as well as environmental conditions while the towing system is in use. Finally, the mat must be stored somewhere while the towing system is in use, which may be in the cab of the truck or rolled up in the cargo bed. As stated above, bed mats are large and unwieldy, and storage of them is inconvenient. Needed in the art is a truck bed mat that allows access to necessary towing systems, while also providing protection to the truck bed while said towing systems are in use.

### BRIEF DESCRIPTION OF THE DRAWINGS

FIG. 1 is a perspective view of a first embodiment of the present invention installed in a truck bed.

FIG. 2 is a perspective view of a first embodiment of the present invention showing the removal of the shaped cutout.

FIG. 3 is a perspective view of a first embodiment of the present invention showing the removal of the shaped cutout and installation of a gooseneck trailer hitch.

FIG. 4 is a perspective view of a first embodiment of the present invention showing the removal of the shaped cutout and installation of a fifth wheel hitch.

FIG. 5 is a perspective view of a second embodiment of the present invention installed in a truck bed.

FIG. 6 is a perspective view of a second embodiment of the present invention installed in a truck bed showing the shaped cutout flipped open.

FIG. 7 is a perspective view of a second embodiment of the present invention installed in a truck bed showing the shaped cutout flipped open and the installation of a gooseneck trailer hitch.

FIG. 8 is a perspective view of a second embodiment of the present invention installed in a truck bed showing the shaped cutout flipped open and the installation of a fifth wheel hitch.

FIG. 9 is a top plan view of a first embodiment of the invention.

FIG. 10 is a top plan view of a first embodiment of the invention with the shaped cutout removed.

FIG. 11 is a top plan view of a second embodiment of the invention.

FIG. 12 is a top plan view of a second embodiment of the invention with the shaped cutout flipped open.

### SUMMARY OF THE INVENTION

It is an object of the invention to provide increased protection for beds of trucks that are used to tow large loads by providing a truck bed mat with a removable shaped cutout which allows access to towing connection points located in the bed of the truck underneath the mat. In some embodiments, the mat may be made of one or more layers of malleable and/or flexile material, including, but not limited to vinyl, rubber, plastic, silicone, or polymer blends. In the preferred embodiment, the truck bed mat comprises a shaped cutout with interlocking tabs that is sized to accommodate either a fifth-wheel towing system or a gooseneck towing system.

In another embodiment, the truck bed mat comprises a partial cutout, wherein at least one side of the partial cutout remains attached to the rest of the truck bed mat and allows the partial cutout to flip open to reveal the connection points for the towing system, while still remaining connected to the truck bed mat as a whole.

### DETAILED DESCRIPTION

Example embodiments will now be described more fully with reference to the accompanying drawings. Example embodiments are provided so that this disclosure will fully convey the scope of the mechanism and operation to one having at least ordinary skill in the art. Numerous specific details are set forth such as examples of specific components, devices, and methods, to provide a thorough understanding of embodiments of the present disclosure. It will be apparent to one having at least ordinary skill in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

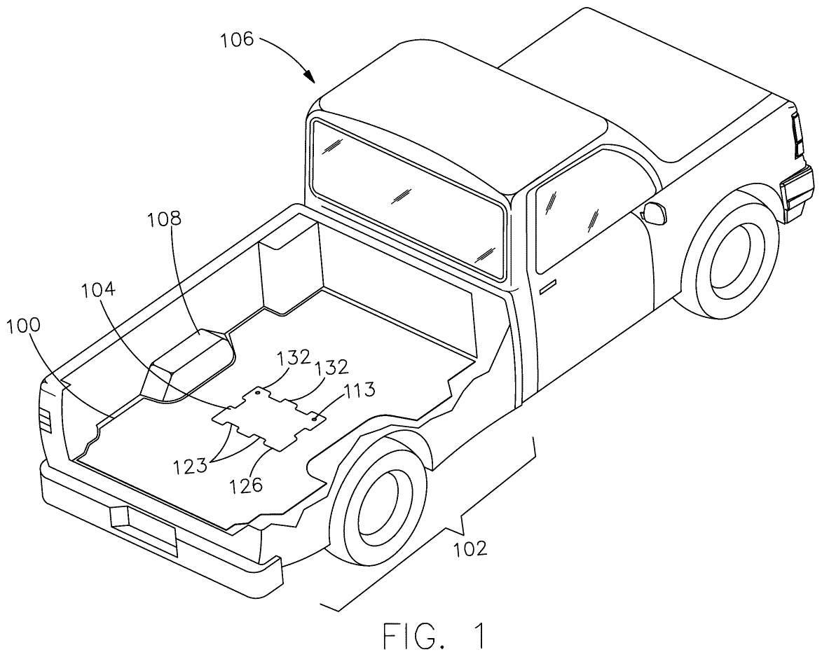

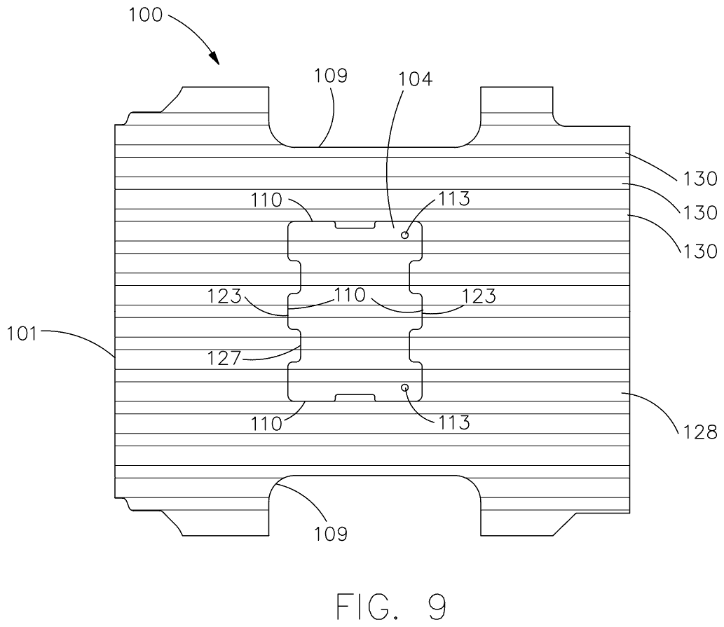

In a first embodiment of the invention, a protective mat 100 for a truck bed 102 is provided and installed in a truck 106, as shown in FIG. 1. In the preferred embodiment, the protective mat 100 is sized to cover the entirety of the bottom of the truck bed 102. The protective mat 100 also includes a shaped cutout 104. In the preferred embodiment, the shaped cutout 104 is located in the middle of the truck bed 102. Also shown in FIG. 1 are wheel wells 108 which are present in many truck beds 102 to accommodate the rear wheels. The shaped cutout 104 is preferably aligned with the wheel wells 108 of the truck 106. This is because in-bed towing equipment will usually be installed above the rear axle of the truck 106, as this area is better at managing the weight of the towed equipment. The shaped cutout 104 further includes one or more interlocking tabs 122 around the exterior edge of the shaped cutout 104. Also shown are shaped indentations 123 in the opening 126 of the protective mat 100, which are configured to receive the interlocking tabs 122 of the shaped cutout 104. These interlocking tabs 122 enable the shaped cutout 104 to fit securely within the protective mat 100. In some embodiments, the shaped cutout 104 further includes one or more finger holes 113 to enable toolless removal of the shaped cutout 104 from the protective mat 100. These finger holes 113 (seen best in FIG. 9) are preferably placed near the corners 113 of the shaped cutout 104 to enable better leverage in the removal of the shaped cutout 104.

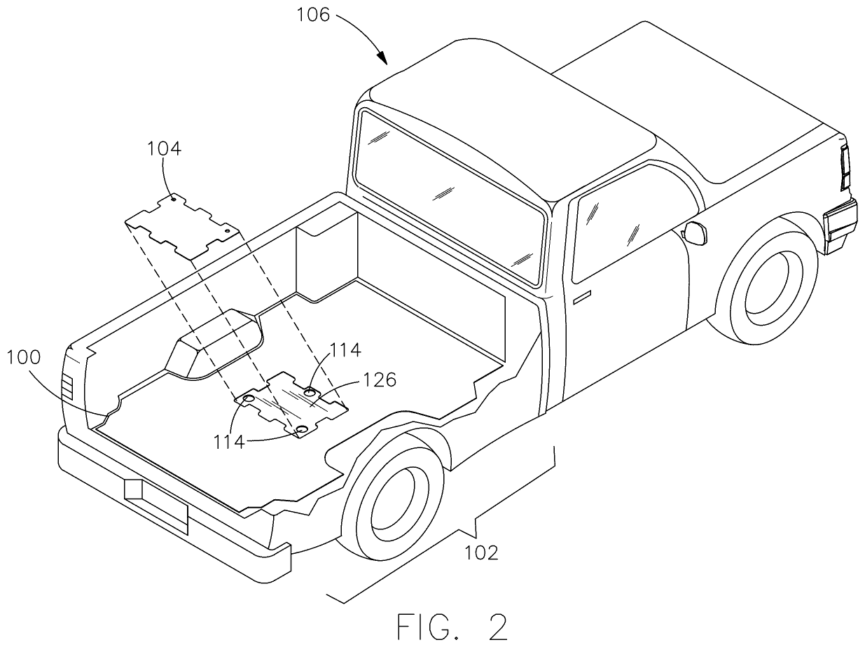

Turning to FIG. 2, shown is another view of a first embodiment of the protective mat 100 of the present invention. In this figure, the shaped cutout 104 has been removed to provide better access to towing connection points 114 located in the truck bed 102.

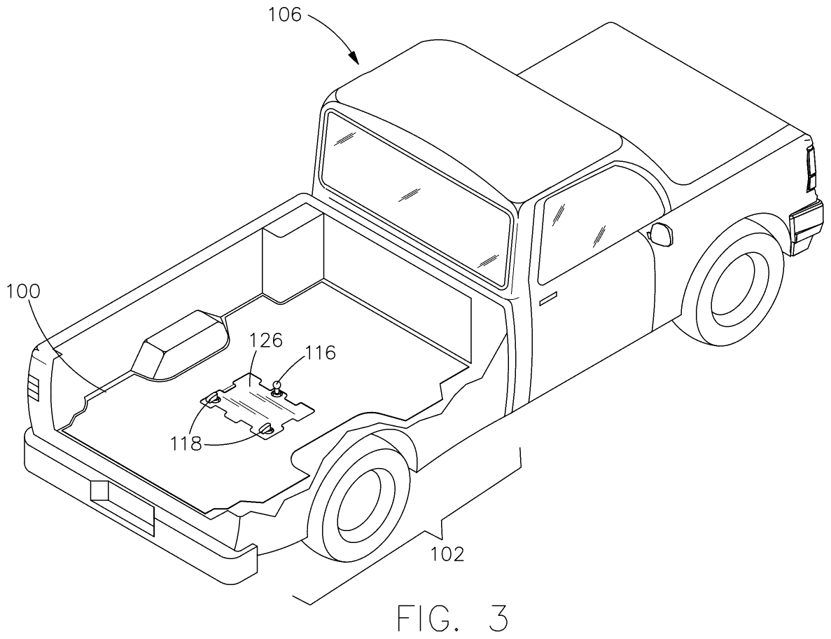

Shown in FIG. 3 is another view of a first embodiment of the protective mat 100 of the present invention. In this figure, the shaped cutout 104 has been removed and a gooseneck hitch 116 and corresponding safety bolts 118 have been installed in the opening 126.

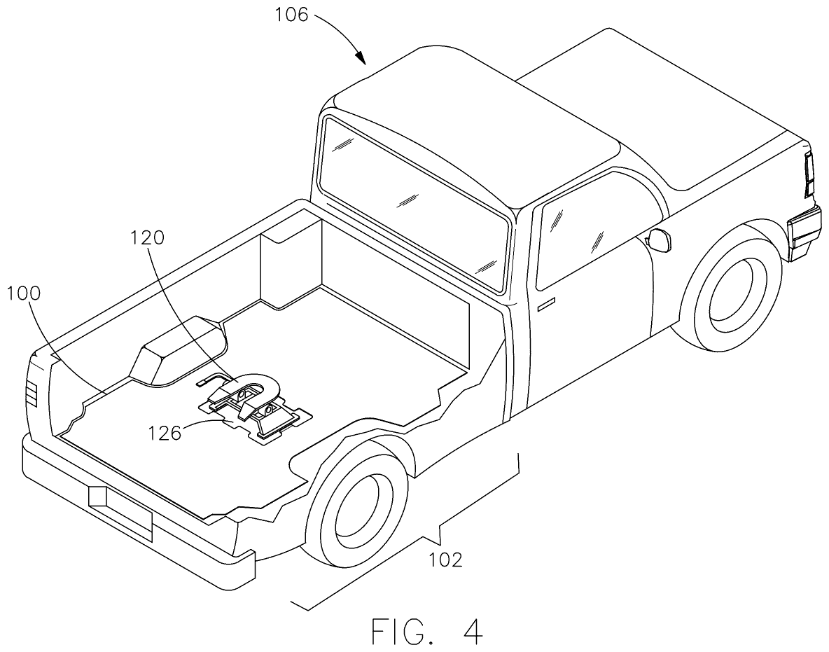

FIG. 4 shows another view of a first embodiment of the protective mat 100 of the present invention. In this figure, the shaped cutout 104 has been removed and a fifth-wheel hitch 120 has been installed in the opening 126.

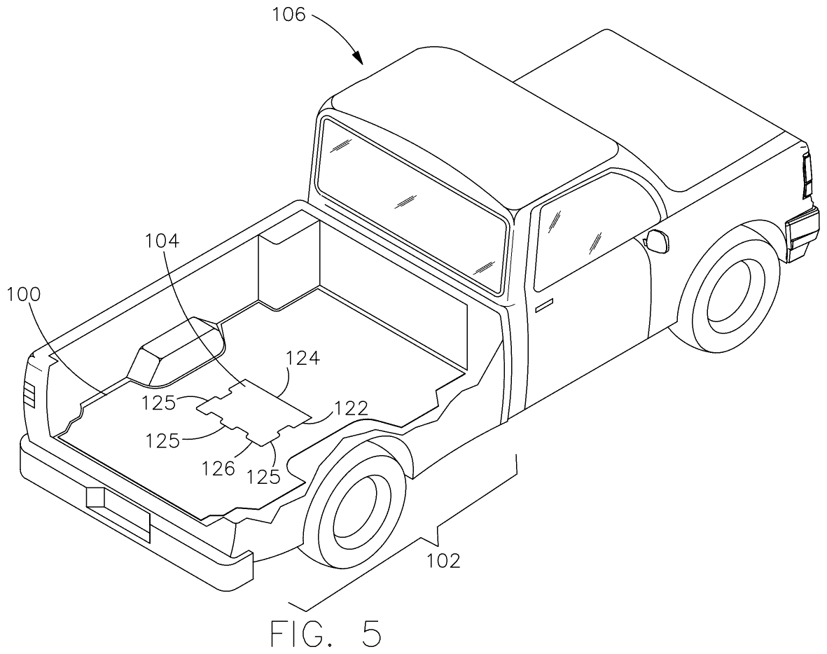

Moving now to FIG. 5, shown is a second embodiment of the invention wherein a protective mat 100 for a truck bed 102 is provided. Also shown in FIG. 5 is a truck 106 which has a protective mat 100 for a truck bed 102 installed therein. In the shown embodiment, the protective mat 100 is sized to cover the entirety of the bottom of the truck bed 102. The protective mat 100 also includes a shaped cutout 104. The shaped cutout 104 is located in the middle of the truck bed 102. The shaped cutout 104 further includes shaped interlocking tabs 122 around the exterior of the shaped cutout 104 on three sides 125. In this embodiment, one side of the shaped cutout 104 is fixed to the opening 126 of the protective mat 100 to form a hinge 124, such that the shaped cutout 104 can be flipped open to provide access to the towing connection points 114 without completely removing the shaped cutout 104 from the protective mat 100.

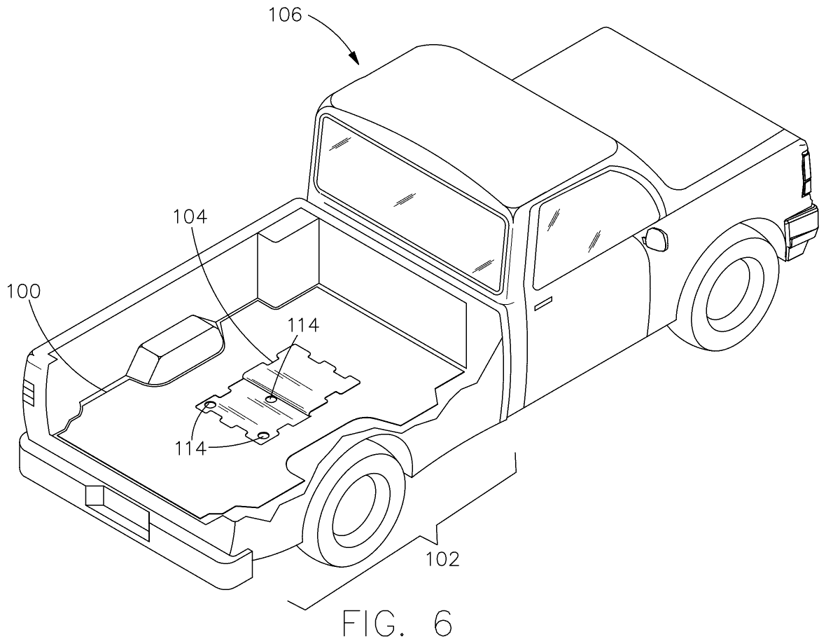

FIG. 6 shows the second embodiment of the invention where the shaped cutout 104 has been flipped open to provide access to towing connection points 114 located in the truck bed 102.

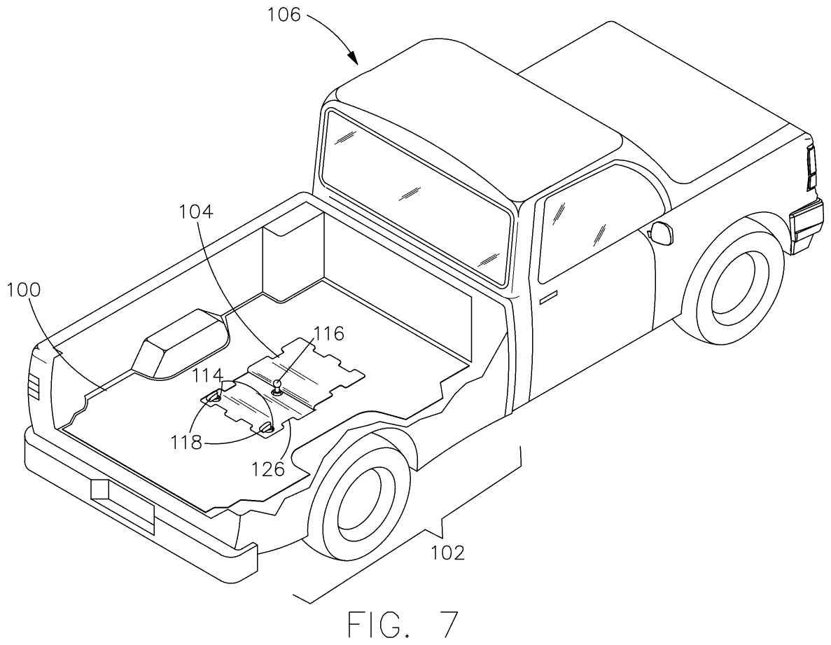

Shown in FIG. 7 is the second embodiment of the protective mat 100 of the present invention where the shaped cutout 104 has been lifted up to provide access to towing connection points 114 located in the truck bed. Also shown in FIG. 7 is towing equipment, specifically a gooseneck hitch 116 and corresponding safety bolts 118 installed in the opening 126.

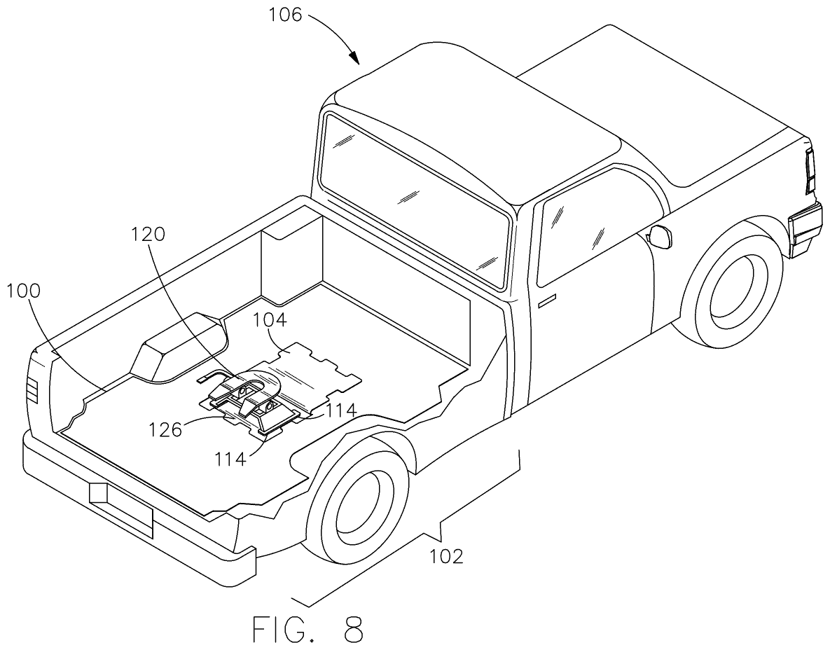

Shown in FIG. 8 is the second embodiment of the protective mat 100 of the present invention where the shaped cutout 104 has been lifted up to provide access to towing connection points 114 located in the truck bed. Also shown in FIG. 8 is towing equipment, specifically a fifth-wheel hitch 120 which has been installed in the opening 126.

Shown in FIG. 9 is a top plan view of the first embodiment of the protective mat 100 of the present invention. In the shown embodiment, the protective mat 100 has an exterior edge 101 that is configured to cover the bottom of a truck bed 106 (not shown). The protective mat 100 is generally rectangular in shape. Notable deviations from the generally rectangular shape are the two large wheel well indentations 109 in the exterior edge 101 of the protective mat 100. The protective mat further includes a shaped cutout 104 which can be removed to provide access to towing connection points 114 located in the truck bed 106. In the shown embodiment, the shaped cutout 104 includes a plurality of interlocking tabs 110 which correspond to shaped indentations 123 on the interior edge 127 of the protective mat 100. In the shown embodiment, there are six interlocking tabs 110, where four interlocking tabs 110 are located on the corners of the shaped cutout 104 and two interlocking tabs 110 are located on the opposed sides of the shaped cutout 104. In some embodiments of the invention, the interlocking tabs 110 are trapezoidal in shape. In some embodiments of the invention, the protective mat may additionally include one or more textured patterns 128 to improve the traction of objects placed on the protective mat 100. In the shown embodiment, the one or more textured patterns 128 consists of a series of grooves 130 that run across the width of the protective mat 100 as pictured. In the preferred embodiment, the one or more textured patterns 128 will continue from the protective mat 100 onto the shaped cutout 104. Also shown in FIG. 9 are the finger holes 113 located in the shaped cutout 104 of the preferred embodiment of the invention.

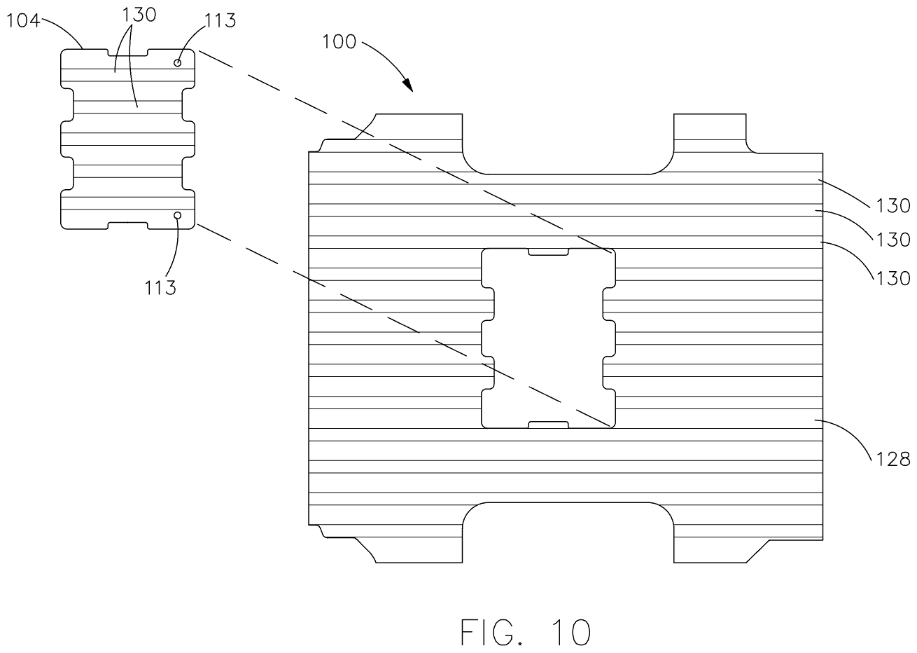

Shown in FIG. 10 is another plan view of a first embodiment of the protective mat 100 of the present invention showing the shaped cutout 104 removed from the protective mat 100. Also shown are the one or more textured patterns 128 to improve the traction of objects placed on the protective mat 100. In the shown embodiment, the one or more textured patterns 128 consists of a series of grooves 130 that run across the width of the protective mat 100 as pictured. However, other types of textured patterns, such as crosses, stars, houndstooth, or dashes, may be used without departing from the scope of the invention. In the preferred embodiment, the one or more textured patterns 128 will continue from the protective mat 100 onto the shaped cutout 104. Also shown in FIG. 10 are the finger holes 113 located in the shaped cutout 104 of the preferred embodiment of the invention.

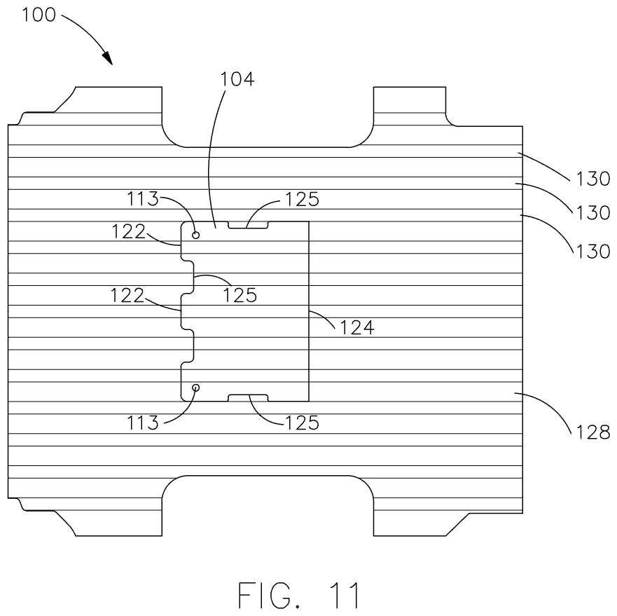

Shown in FIG. 11 is a top plan view of a second embodiment of the protective mat 100 of the present invention. In the shown embodiment, the shaped cutout 104 further includes shaped interlocking tabs 122 around the exterior of the shaped cutout 104 on three sides. In this embodiment, one side comprises a fixed hinge 124, such that the shaped cutout 104 can be lifted up without detaching the shaped cutout 104 from the protective mat 100. In some embodiments of the invention, the protective mat may additionally include one or more textured patterns 128 to improve the traction of objects placed on the protective mat 100. In the shown embodiment, the one or more textured patterns 128 consists of a series of grooves 130 that run across the width of the protective mat 100 as pictured. In the preferred embodiment, the one or more textured patterns 128 will continue from the protective mat 100 onto the shaped cutout 104. Also shown in FIG. 11 are the finger holes 113 located in the shaped cutout 104 of the preferred embodiment of the invention.

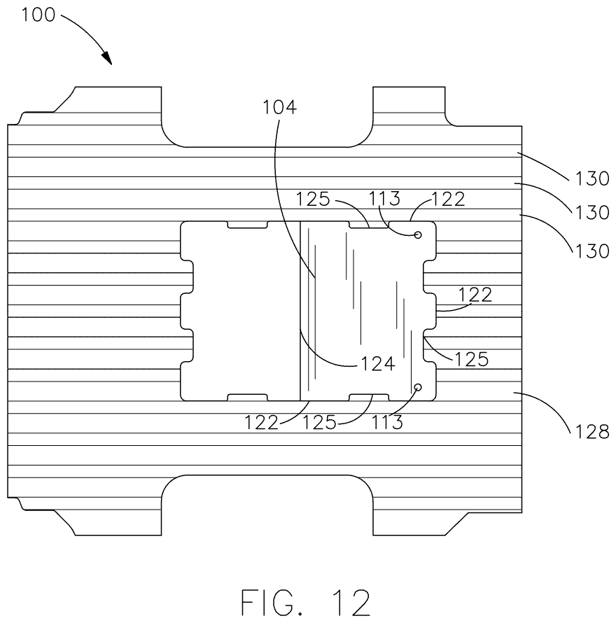

Shown in FIG. 12 is another plan view of a second embodiment of the protective mat 100 of the present invention. In the shown embodiment, the shaped cutout 104 further includes shaped interlocking tabs 122 around the exterior of the shaped cutout 104 on three sides. In this embodiment, one side comprises a fixed hinge 124, such that the shaped cutout 104 can be lifted up without detaching the shaped cutout 104 from the protective mat 100. In some embodiments of the invention, the protective mat may additionally include one or more textured patterns 128 to improve the traction of objects placed on the protective mat 100. In the shown embodiment, the one or more textured patterns 128 consists of a series of grooves 130 that run across the width of the protective mat 100 as pictured. In the preferred embodiment, the one or more textured patterns 128 will continue from the protective mat 100 onto the shaped cutout 104.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, affixed, joined) are to be construed broadly and may include intermediate members between a connection of elements and relative movement between elements. As such, joinder references do not necessarily infer that two elements are directly connected and in fixed relation to each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements, and/or substantial equivalents.

What is claimed is:

1) A protective mat for a truck bed comprising:
A removable shaped cutout; wherein said removable shaped cutout comprises one or more interlocking tabs around the exterior edge of said shaped cutout, and wherein said protective mat further comprises an opening for receiving said removable shaped cutout.

2) The protective mat of claim 1, wherein said opening further comprises one or more shaped indentations around the edge of said opening.

3) The protective mat of claim 2, wherein the number of said one or more interlocking tabs corresponds to the number of said one or more shaped indentations.

4) The protective mat of claim 3, wherein said removable shaped cutout further comprises one or more finger holes.

5) The protective mat of claim 4, wherein said removable shaped cutout is rectangular in shape, wherein said removable shaped cutout further comprises four corners.

6) The protective mat of claim 5, wherein said one or more finger holes are located in one or more corners of said removable shaped cutout.

7) The protective mat of claim 6 wherein said protective mat further comprises one or more textured patterns on the surface of said protective mat.

8) The protective mat of claim 7 wherein said one or more textured patterns comprises a series of spaced grooves across the surface of said protective mat.

9) A protective mat for a truck bed comprising:
a shaped cutout having an exterior edge around said shaped cutout, wherein said shaped cutout comprises one or more interlocking tabs around said exterior edge of said shaped cutout, wherein said protective mat further comprises an opening for receiving said shaped cutout, wherein said shaped cutout is rectangular in shape, and wherein said shaped cutout is connected to said protective mat along one edge of said shaped cutout.

10. The device of claim 9, wherein said opening further comprises one or more shaped indentations around three edges of said opening.

11. The device of claim 10, wherein the number of said one or more interlocking tabs corresponds to the number of said one or more shaped indentations.

12. The device of claim 11, wherein said shaped cutout further comprises one or more finger holes.

13. The device of claim 12, wherein said shaped cutout is rectangular in shape.

14. The device of claim 13, wherein said one or more finger holes are located in one or more corners of said shaped cutout.

15. The device of claim 14 wherein said protective mat further comprises one or more textured patterns on the surface of said protective mat.

16. The device of claim 15 wherein said one or more textured patterns comprises a series of spaced grooves across the surface of said protective mat.

17. A protective mat for a truck bed comprising:
A protective mat configured to be placed in a truck bed, wherein said protective mat is of sufficient size and shape to cover the entirety of the bottom of said truck bed;
a shaped cutout positioned above at least one towing connection point located in said truck bed, wherein said shaped cutout comprises one or more interlocking tabs around the exterior edge of said shaped cutout; wherein said protective mat further comprises at least one opening, wherein said opening further comprises one or more shaped indentations around the interior edge of said opening, wherein said one or more interlocking tabs correspond to said one or more shaped indentations.

18. The protective mat of claim 17, wherein said opening is of sufficient size to provide access to said at least one towing connection point.

19. The protective mat of claim 17 wherein said protective mat further comprises one or more textured patterns on the surface of said protective mat.

20. The protective mat of claim 19 wherein said one or more textured patterns comprises a series of spaced grooves across the surface of said protective mat.
